(19) United States
(12) Patent Application Publication
(10) Pub. No.: US 2017/0291716 A1
(43) Pub. Date: Oct. 12, 2017

(54) COCKPIT AUGMENTED VISION SYSTEM FOR AIRCRAFT

(71) Applicant: Gulfstream Aerospace Corporation, Savannah, GA (US)

(72) Inventors: Scott Buethe, Savannah, GA (US); Nicholas Kershaw, Savannah, GA (US); Jeffrey Hausmann, Savannah, GA (US); Donald Mentch, Savannah, GA (US); Liam Bruen, Savannah, GA (US)

(21) Appl. No.: 15/092,896

(22) Filed: Apr. 7, 2016

(51) Int. Cl. B64D 45/00; A62B 18/02; H04N 5/64; H04N 5/272; H04N 7/18; H04N 5/268

(52) U.S. Cl. CPC B64D 45/00; H04N 7/183; H04N 5/268; H04N 5/64; H04N 5/272; A62B 18/02

(57) ABSTRACT

The disclosed embodiments relate to a cockpit augmented vision unit (CAVU) is provided that includes a video signal feed, a housing configured to house a display, and an attachment mechanism coupled to the housing that is configured to secure the housing and the display to an oxygen mask. The video signal feed can be communicatively coupled to at least one source of a video signal, and the display can be coupled to the video signal feed. The display is configured to display the video signal.

### TECHNICAL FIELD

Embodiments of the present invention generally relate to aircraft, and more particularly relate to displaying information in a cockpit of an aircraft.

### BACKGROUND

Modern aircraft include arrays of electronic displays, instruments, and sensors designed to provide the pilot with functional information, menus, data, and graphical options intended to enhance pilot performance and overall safety of the aircraft and the passengers. Some displays are programmable and/or customizable and some are also used by the pilot(s) as the primary instrument display for flying the aircraft. These displays are commonly referred to as the Primary Flight Displays (PFD) and are assigned or dedicated to both the pilot and copilot. PFDs display information such as aircraft altitude, attitude, and airspeed. All displays typically include a separate controller, including knobs, radio buttons, and the like, to select different menus and graphical presentations of information on the displays. Additionally, the cockpit instrument panel includes individual controllers for specific aircraft systems, such as the fuel system, the electrical power system, weather detection system, etc.

When an aircraft is in flight, it is imperative that the pilot can view the flight deck displays so that he/she can properly fly the aircraft. Normally this is not an issue. However, when smoke or another visual obscurant enters the cockpit of the aircraft, this could cause significant visual attenuation. Flight crew use oxygen masks to assist with breathing, but the visual impairment issues can make it difficult, if not impossible, for the pilot and co-pilot to see the primary or secondary flight displays, the flight deck controls or even the flight path outside the aircraft.

One solution to this problem is the Emergency Visual Assurance System (EVAS). EVAS is a self-contained system that includes a battery powered blower which draws smoky air in through a filter that filters out visible particles to a flexible air duct, which is connected to an inflatable transparent envelope, called an Inflatable Vision Unit (IVU). In essence, it uses an air displacement device that draws air through a filter and removes smoke/visible particles, then inflates a large bag with cleaner air. The inflated bag therefore “displaces” the smoke in the cockpit providing the crew with a limited view to the flight deck. However, a drawback of EVAS is that it takes at least 1 minute before it can be fully inflated and used.

There is a need for alternative technologies that allow pilots and flight crew to view the flight deck instrumentation when obscurants, such as smoke, enter the cockpit. Furthermore, other desirable features and characteristics of the present invention will become apparent from the subsequent detailed description and the appended claims, taken in conjunction with the accompanying drawings and the foregoing technical field and background.

### SUMMARY

A method is provided for communicating a video signal from a source inside an aircraft, and displaying the video signal on a display that is configured to be secured to an oxygen mask of the aircraft.

In one embodiment, a Cockpit Augmented Vision Unit (CAVU) is provided that includes a video signal feed, a housing configured to house or contain a display, and an attachment mechanism coupled to the housing configured to secure the housing and the display to an oxygen mask. The video signal feed can be communicatively coupled to at least one source of a video signal, and the display can be coupled to the video signal feed. The display is configured to display the video signal.

In another embodiment, an aircraft system is provided. The system includes an aircraft having at least one source of a video signal, and an oxygen mask that can be deployed within the aircraft. A Cockpit Augmented Vision Unit (CAVU) is communicatively coupled to the source, and includes a housing configured to house a display; and an attachment mechanism coupled to the housing that is configured to secure the display to the oxygen mask. The display can display the video signal.

### DESCRIPTION OF THE DRAWINGS

Embodiments of the present invention will hereinafter be described in conjunction with the following drawing figures, wherein like numerals denote like elements, and wherein

FIG. 1 is a perspective view of one non-limiting implementation of an aircraft in which the disclosed embodiments can be implemented;

FIG. 2 is a block diagram of an aircraft computer system in accordance with an exemplary implementation of the disclosed embodiments;

FIG. 3 is a view of aircraft cockpit instrumentation in accordance with one non-limiting embodiment;

FIG. 4 is a schematic of a cockpit augmented vision unit (CAVU) mounted on an oxygen mask in accordance with an embodiment; and

FIG. 5 is a block diagram of an aircraft system that includes a CAVU and various video signals that can be provided by an aircraft in accordance with an embodiment.

### DETAILED DESCRIPTION

As used herein, the word “exemplary” means “serving as an example, instance, or illustration.” The following detailed description is merely exemplary in nature and is not intended to limit the invention or the application and uses of the invention. Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary or the following detailed description.

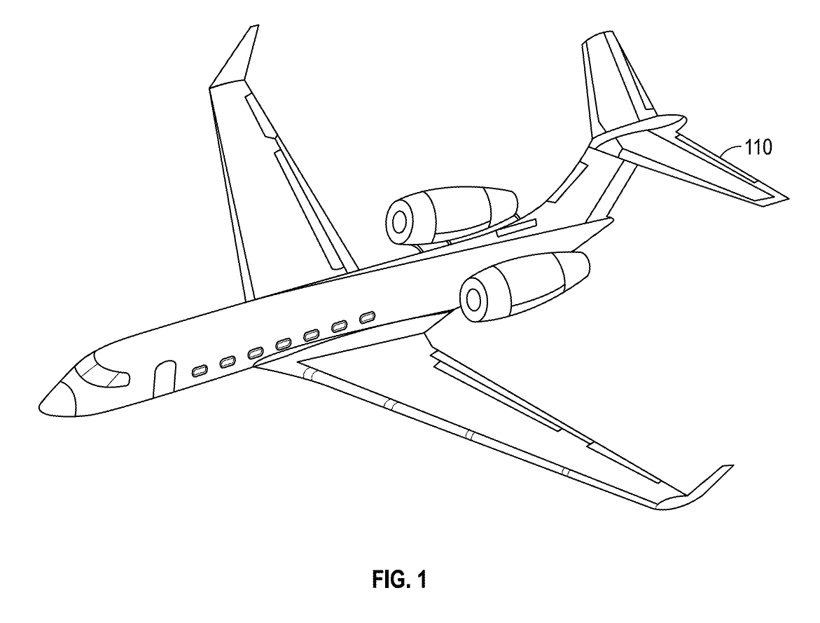

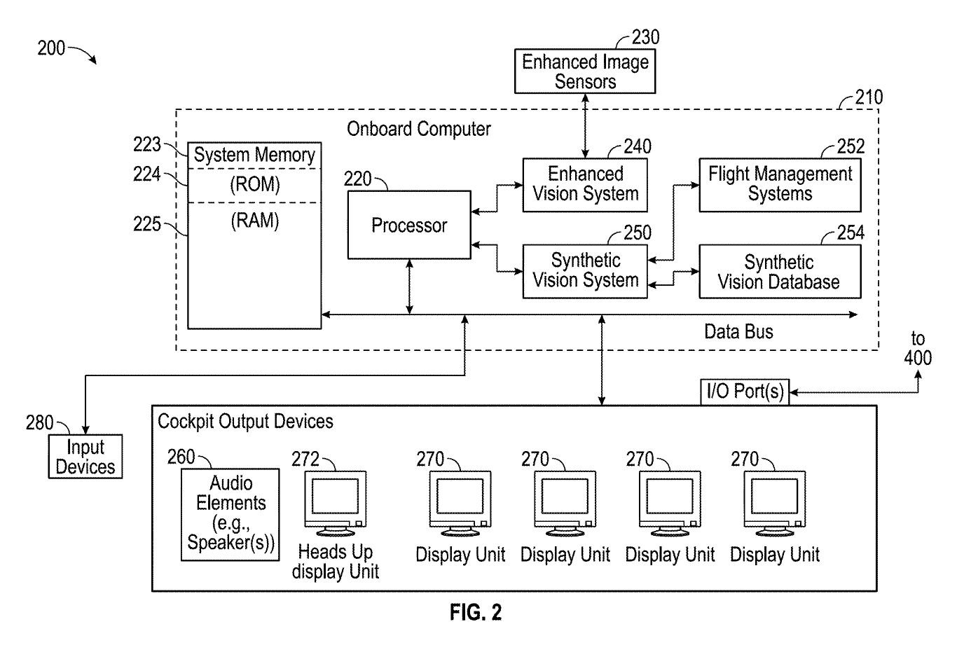

FIG. 1 is a perspective view of one non-limiting implementation of an aircraft 110 in which the disclosed embodiments can be implemented. Although not shown in FIG. 1, the aircraft 110 also includes an onboard computer, aircraft instrumentation and various control systems as will now be described with reference to FIG. 2.

FIG. 2 is a block diagram of an aircraft computer system 200 in accordance with an exemplary implementation of the disclosed embodiments. As shown, the system 200 includes an onboard computer 210, enhanced image sensors 230, cockpit output devices including audio elements 260, such as speakers, etc., display units 270 such as control display units, multifunction displays (MFDs), etc., a heads up display unit 272, and various input devices 280 such as a keypad which includes a cursor controlled device, and one or more touchscreen input devices which can be implemented as part of the display units. Although not illustrated in FIG. 2, the aircraft can include various aircraft instrumentation such as, for example, the elements of a Global Position System (GPS), which provides GPS information regarding the position and speed of the aircraft, elements of an Inertial Reference System (IRS), proximity sensors, etc. In general, the IRS is a self-contained navigation system that includes inertial detectors, such as accelerometers, and rotation sensors (e.g., gyroscopes) to automatically and continuously calculate the aircraft's position, orientation, heading and velocity (direction and speed of movement) without the need for external references once it has been initialized.

The display units 270 can be implemented using any man-machine interface, including but not limited to a screen, a display or other user interface (UI). In response to display commands supplied from the input devices 280, the display units 270 can selectively render various textual, graphic, and/or iconic information in a format viewable by a user, and thereby supply visual feedback to the operator. It will be appreciated that the display units 270 can be implemented using any one of numerous known displays suitable for rendering textual, graphic, and/or iconic information in a format viewable by the operator. Non-limiting examples of such displays include various cathode ray tube (CRT) displays, and various flat panel displays such as various types of liquid crystal display (LCD) and thin film transistor (TFT) displays. The display units 270 may additionally be implemented as a panel mounted display, a head-up display (HUD) projection, or any one of numerous technologies used as flight deck displays in aircraft. For example, it may be configured as a multi-function display, a horizontal situation indicator, or a vertical situation indicator. At least one of the display units 270 can be configured as a primary flight display (PFD). Depending on the implementation or mode of operation, the heads up display (HUD) unit 272 can be an actual physical display or implemented using projected images (e.g., images projected on a surface within the aircraft such as the windshield).

The audio elements 260 can include speakers and circuitry for driving the speakers. The input devices 280 can generally include, for example, any switch, selection button, keypad, keyboard, pointing devices (such as a cursor controlled device or mouse) and/or touch-based input devices including touch screen display(s) which include selection buttons that can be selected using a finger, pen, stylus, etc.

The onboard computer 210 includes a data bus 215, a processor 220, system memory 223, a synthetic vision system (SVS) 250, a SVS database 254, flight management systems (FMS) 252, and an enhanced vision system (EVS) 240 that receives information from EVS image sensor(s) 230.

The data bus 215 serves to transmit programs, data, status and other information or signals between the various elements of FIG. 2. The data bus 215 is used to carry information communicated between the processor 220, the system memory 223, the enhanced image sensors 230, the enhanced vision system (EVS) 240, synthetic vision system (SVS) 250, FMS 252, cockpit output devices 260, 270, 272, and various input devices 280. The data bus 215 can be implemented using any suitable physical or logical means of connecting the on-board computer 210 to at least the external and internal elements mentioned above. This includes, but is not limited to, direct hard-wired connections, fiber optics, and infrared and wireless bus technologies such as Bluetooth and Wireless Local Area Network (WLAN) based technologies.

The processor 220 performs the computation and control functions of the computer system 210, and may comprise any type of processor 220 or multiple processors 220. The processor 220 may be implemented or realized with a general purpose processor, a content addressable memory, a digital signal processor, an application specific integrated circuit, a field programmable gate array, any suitable programmable logic device, discrete gate or transistor logic, discrete hardware components, or any combination designed to perform the functions described herein. A processor device may be realized as a microprocessor, a controller, a microcontroller, or a state machine. Moreover, a processor device may be implemented as a combination of computing devices, e.g., a combination of a digital signal processor and a microprocessor, a plurality of microprocessors, one or more microprocessors in conjunction with a digital signal processor core, or any other such configuration.

It should be understood that the system memory 223 may be a single type of memory component, or it may be composed of many different types of memory components. The system memory 223 can includes non-volatile memory (such as ROM 224, flash memory, etc.), volatile memory (such as RAM 225), or some combination of the two. The RAM 225 can be any type of suitable random access memory including the various types of dynamic random access memory (DRAM) such as SDRAM, the various types of static RAM (SRAM).

In addition, it is noted that in some embodiments, the system memory 223 and the processor 220 may be distributed across several different on-board computers that collectively comprise the on-board computer system 210.

The processor 220 is in communication with the EVS 240, the SVS 250 and flight management system (FMS) 252.

The FMS 252 is a specialized computer system that automates a wide variety of in-flight tasks. For example, the FMS 252 allows for in-flight management of the flight plan, and can provide data such as vehicle positioning, heading, attitude, and a flight plan to the SVS 250. The FMS 252 can use various sensors (such as GPS and INS) to determine the aircraft's position, and guide the aircraft along the flight plan.

The EVS 240 can include a processor (not shown) that generates images for display on the heads up display (HUD) unit 272. The images provide a view, looking forward, outside the aircraft 110. The EVS 240 can receive output of one or more nose-mounted EVS image sensors 230 (e.g., infrared and/or millimeter wave video cameras). In one embodiment, the EVS 240 transmits images to a transparent screen in the pilot's forward field of vision, creating a seamless, uninterrupted flow of information that increases a pilot's situational awareness and response. The EVS 240 can be specifically tuned to pick up runway lights or other heat emitting objects through cloud and other precipitation, and can also show the pilot a horizon and some terrain. The EVS 240 can reveal, for example, taxiways, runway markings, adjacent highways and surrounding terrain, etc. even at night, in light fog or rain, etc. The EVS image sensors 230 can surrounded by an artificial cooling system that better enables the infrared receivers to detect the slightest variations in infrared light emitted from runway lights, airports and even vehicles on the ground.

The SVS 250 can include a processor (not shown) that communicates with the SVS database 254 and the flight management system (FMS) 252. The SV database 254 includes data related to, for example, terrain, objects, obstructions, and navigation information for output to one or more of the display units 270. In one embodiment, the SVS 250 is configured to render images based on pre-stored database information. These images can include three-dimensional color maps provide a geographic display that includes an accurate terrain representation of surrounding terrain, runways and approaches. In addition, in some embodiments, PFD information such as altitude, attitude, airspeed, turn and bank cues can be superimposed over the geographic display.

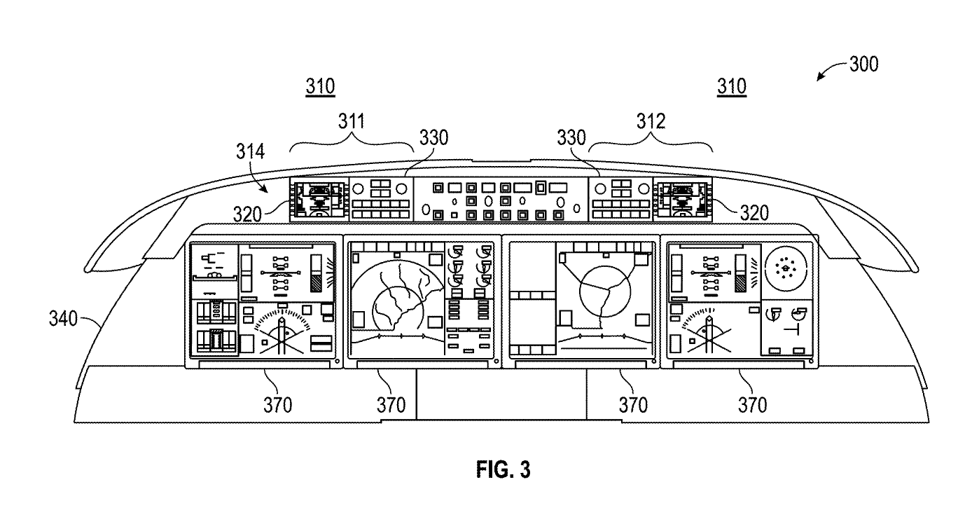

FIG. 3 is a view of aircraft cockpit instrumentation 300 in accordance with one non-limiting embodiment. The cockpit instrumentation 300 is positioned below windshield windows 310 and includes a glare shield 314 and a main instrument panel 340. The cockpit instrumentation 300 includes four display units 370 (also referred to herein as multifunction display units) and two standby display/controllers 311, 312, mounted in the main instrument panel 340, for controlling the display units 370. The standby display/controllers 311, 312 can be positioned directly below the windshield 310 and above the display units 370 to aid the pilot during instrument scans and to ease the ability of the pilot to make adjustments to the aircraft systems and displays. Although the standby display/controllers 311, 312 are shown in FIG. 3 as being positioned in the glare shield 314 and directly above the display units 370, it should be understood that the standby display controllers 311, 312 may also be positioned elsewhere on the cockpit instrumentation 300. Likewise other instruments such as the display units 370 may be otherwise positioned on the cockpit instrumentation 300 without deviating from the scope and spirit of the present invention.

During normal flight conditions, the display units 370 provide the pilot with the vast majority of necessary information used in piloting an aircraft. As the primary instruments, the display units 370 display flight data according to various functions and, in a modern aircraft, are typically programmable by the pilot. One of the display units 370 is assigned to a pilot and can function as the PFD that can display attitude, airspeed, heading, etc.

Each standby display/controller 311, 312 includes a display 320 and a companion controller panel 330, and may be associated with a pilot or copilot and one or more of the display units 370. The standby display/controllers 311, 312 may provide control for and display of aircraft systems and control for display units 370. By functioning as both a configurable controller and as a standby display, the display/controllers 311, 312 may integrate not only the functions of the traditional configurable controllers, standby display and standby heading display. The standby display/controllers 311, 312 typically control the programmable display units 370 such that the display units 370 may display attitude and airspeed information, as well as navigational or systems information, according to the preferences of a pilot. For example, through the display controller 320, a pilot may configure the display 370. In addition to controlling and configuring the display units 370, the controller 320 may also be configured to control aircraft systems and display the status of aircraft systems on an associated screen shown. For example, the controller 320 may be configured to control and display status information regarding the fuel system or the auxiliary power unit for the aircraft. As such, through the control of the displays and the aircraft systems, the controller 320 plays a significant role in the flight of the aircraft.

The standby display/controllers 311, 312 may be configured to include a controller mode and a standby mode. In the controller mode, each standby display/controller 311, 312 presents aircraft system data and menu options for managing the aircraft systems, and may display data for an automatic flight control system.

In the event of an emergency or if the display units 370 are lost (e.g., during abnormal conditions such as an electrical failure), the display units 370 may not be available to the pilot and/or the copilot, the display/controllers 311, 312 may be configured to default to the standby mode. In such an emergency situation, standby display/controller 311, 312 can provide the pilots with the necessary information in a standardized fashion. In the standby mode, at least one of the standby display/controllers 311, 312 displays required regulatory flight data at all times. Video signals from a source (e.g., display) inside a cockpit of an aircraft can be provided to a vision unit that is secured to an oxygen mask within the aircraft. Additionally, in some embodiments, actual video images of the cockpit can be acquired via a camera and provided to the vision unit. A user (e.g., pilot or crew member) can select a particular one of the video signals or the actual video images that are to be displayed at a display of the vision unit.

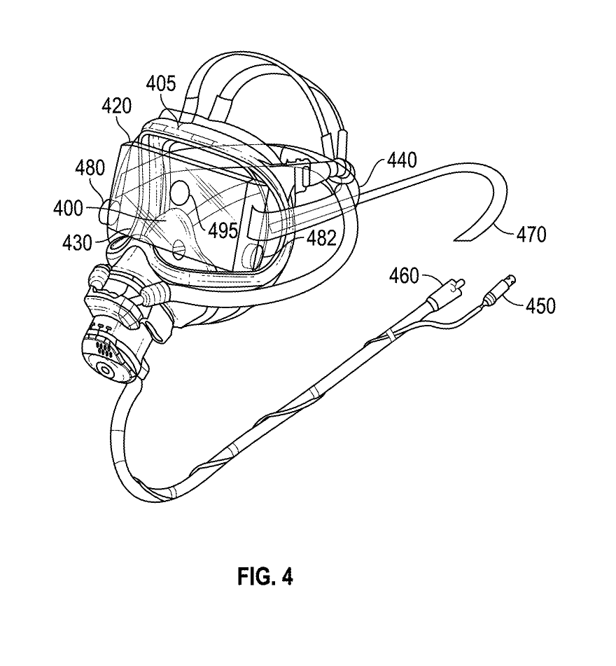

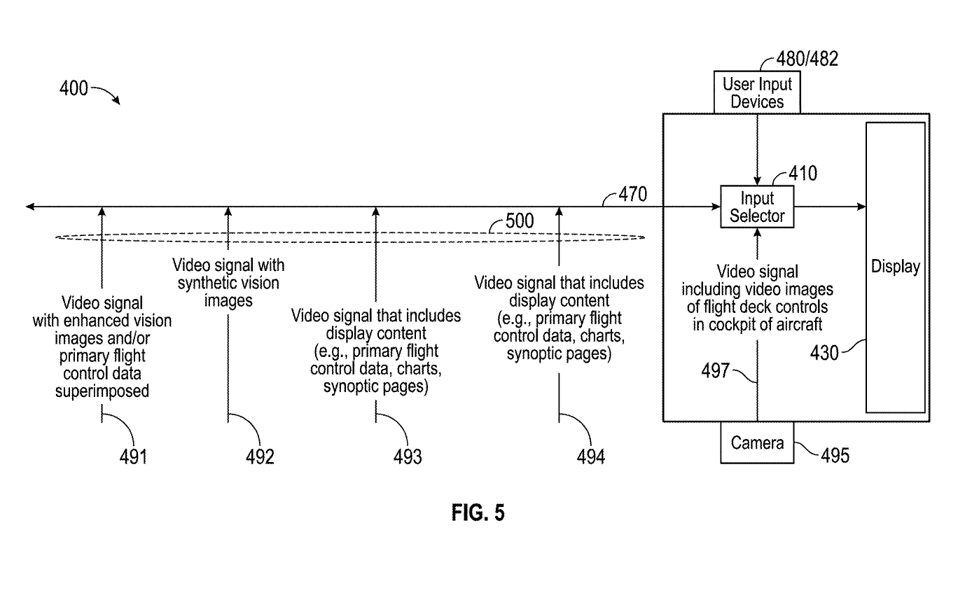

FIG. 4 is a schematic of a cockpit augmented vision unit (CAVU) 400, mounted on an oxygen mask 405, in accordance with an embodiment. In this embodiment, the CAVU 400 is mountable on an oxygen mask 405. In other words, the oxygen mask 405 is not part of the CAVU 400, but is used within the aircraft 110 in certain circumstances (e.g., any situation indicative of low oxygen levels) when it is necessary to ensure that pilots or crew have a sufficient supply of oxygen. To do so, the oxygen mask 405 includes an oxygen supply line 460, and optionally a microphone 450 for the oxygen mask 405. In situations where an obscurant, such as smoke, impairs the visibility of the flight deck and its various components, the CAVU 400 can be installed over that oxygen mask 405 to provide the pilot with visual information that he/she would normally have absent the visual obscurant. The CAVU 400 includes a housing 420, a display 430 mounted within the housing 420, an attachment mechanism 440, one or more video signal feed(s) 470, user input devices 480, 482, and an optional camera 495. FIG. 4 will be described in greater detail below with reference to FIG. 5. In the embodiment illustrated in FIG. 4, the CAVU 400 is mountable on an oxygen mask 405; however, in other embodiments, the CAVU 400 or components thereof such as the display (or display device) can be integrated with the oxygen mask 405 (e.g., permanently integrated with and part of the oxygen mask).

FIG. 5 is a block diagram of an aircraft system that includes a CAVU 400 and various video signals 500 that can be provided by an aircraft 110 in accordance with an embodiment. FIGS. 4 and 5 will be described together with continuing reference to FIGS. 1-3.

The CAVU 400 is mountable on an oxygen mask 405, and includes an input selector 410, a housing 420, a display 430, an attachment mechanism 440, one or more video signal feed(s) 470, user input devices 480, 482, and an optional camera 495. The video signal feed 470 can be communicatively coupled to various blocks 240, 250, 252, 270, 272, 272, 276 of FIG. 2 via one or more port(s) in the cockpit of the aircraft 110.

The display 430 can be housed within the housing 420 such that the display 430 is contained (at least partially) within the housing 420. The attachment mechanism 440 can be attached or coupled to the housing 420. The attachment mechanism 440 is used to secure the CAVU to the oxygen mask 405 when needed. The attachment mechanism 440 allows for the CAVU 400 to be quickly mounted flush with the oxygen mask, and easily removed in situations where the oxygen mask 405 is required but the display 430 is not required (e.g. rapid decompression). The attachment mechanism 440 allows the user (e.g., pilot or crew) to secure the housing 420, and hence the display 430, to an oxygen mask 405 that is deployed within the cockpit under certain circumstances, such as when smoke or other visual obscurants start to enter the cockpit. This allows the user to view information that is presented on the display 430 when the CAVU 400 is attached to and worn over the oxygen mask 405. In one embodiment, the attachment mechanism 440 can be an adjustable, elastic head strap that allows for quick and easy attachment of the CAVU 400 to the oxygen mask 405. In one implementation, the housing 420 can include soft padding or a seal that contacts against the oxygen mask 405 when mounted on the oxygen mask 405.

The video signal feed 470 can be implemented using cables that are compliant with component video, composite video (e.g., NTSC, PAL or SECAM), or s-video standards. The display 430 can be indirectly coupled to the video signal feed 470 via the input selector 410. The user input devices 480, 482 can receive inputs from the user (referred to herein as “user input”), which is provided to the input selector 410 to control which source of video information is displayed on the display 430. In one embodiment, the user input devices can include a switch button 480 that is used to toggle between selection of the video camera 495 and the other video signals, and another switch button 482 that is used to switch between select a particular one of the video signals.

In some embodiments, a video camera 495 can be integrated with and/or mounted on the housing 420. The video camera 495 operates using a portion of the electromagnetic spectrum to provide penetration of obscurants such as smoke. The video camera 495 can be, for example, a shortwave infrared (IR) or near IR camera. The video camera 495 can be augmented by in-band illumination sources (e.g., IR LEDs) inside the flight deck. In one embodiment, to enhance the visibility of flight deck controls to the user the illumination sources will be located close to primary controls. The video camera 495 provides the user with a view of the flight deck and allows the flight deck to be viewed by the user through dense smoke or similar obscurants that would normally prevent the user from seeing them. The video camera 495 can be used to acquire video images 497 of the cockpit of the aircraft 110, including actual images of flight deck controls and display units 270 located within the cockpit of the aircraft 110, when normal viewing of the flight deck controls and the display units 270 is visually attenuated, obscured or impaired in some way. In addition, in other embodiments, the CAVU 400 can communicate with other video cameras that are mounted anywhere within the cockpit, and can receive video images acquired by those cameras. In one embodiment, the video camera 495 can be removable, which allows the user to move it to another location in the cockpit (e.g., the windshield). Alternatively, one or more other video cameras (not shown) can be provided that can be mounted anywhere within the cockpit, and can receive real-time video images acquired by those cameras, which can in turn be communicated to the video input selector 410 of the CAVU 400 to provide additional sources of video information.

The CAVU 400 includes a port (not illustrated) that receives the video signal feed 470, and couples it to the video input selector 410 of the CAVU 400. The video input selector 410 is coupled to the camera 495, the user input devices 480, 482 and the display 430. The input selector 410 receives the various video signals 500 via the video signal feed 470 and the video images 497 of the cockpit that are acquired by the video camera 495. The video signal feed 470 carries video information from various different sources onboard the aircraft, and provides them to the input selector 410. The video signal feed 470 can carry video signals 500 received from different displays 270-276 within the cockpit, but it should be appreciated that these sources are not limited to these displays 270-276 and can include other sources depending on the implementation.

The user can interact with the input devices 480, 482 to generate user input signals that are used to control which source of video information is displayed on the display 430. The input devices 480, 482 can generally include, for example, any switch, selection button, and/or touch-based input devices which include selection buttons that can be selected using a finger. Each user input device is configured to receive user inputs that are provided to the input selector 410. In response to the user inputs from the user input devices, the input selector 410 can select one of its video inputs (e.g., either the video images 497 from the camera 495 or one of the different/unique video signals 500) that will be output to the display 430.

The user input devices 480, 482 can be implemented using switches, such as rotary switches, or any type of touch sensitive control devices including, for example, switch buttons. In one embodiment, the user input devices can include a switch button 480 that is used to select the video images 497 from the video camera 495 as the output for the display 430, and another switch button 482 that is used to select and switch between the video signals 500 to select a particular one of the video signals 500 as the output for the display 430. When the user selects one particular video signal 500 as the desired output, the CAVU 400 can provide that particular video signal 500 to the display 430 for presentation to the user.

When in operation, a user (e.g., pilot or crew) can use the input devices 480/482 to select from different, unique sources of video information that can be repeated and displayed at the display 430. Stated differently, in response to user input, the video input selector 410 will output either one of the different video signals 500 that drive the display units 270, 272, or the video images 497 of the cockpit to display the selected video information to the user via the display 430.

In the embodiment illustrated in FIG. 5, the different sources of video information can include four different and unique video signals 500 that are replicated or repeated from displays within the cockpit, and actual video images of the cockpit that are acquired via camera 495. The video signals 500 in FIG. 5 include a video signal 491 that includes information provided from a HUD 272 within the cockpit of the aircraft 110, a video signal 492 provided from a display unit 270 within the cockpit of the aircraft 110, and video signals 493, 494 that include the content displayed at the display units 270, 272 within the cockpit of the aircraft 110. The video signal 491 can include, for example, enhanced vision images generated by an enhanced vision system 240. In one embodiment, primary flight control data is superimposed on the enhanced vision images. The video signal 492 can include, for example, synthetic vision images 255 generated by a SVS 250. The video signals 493, 494 can include information provided from an FMS 252, including one or more of primary flight control data, charts, synoptic system pages for aircraft systems, other “secondary” flight control data, menu options and control for various aircraft systems and devices including those associated with aircraft sensors, standby flight displays, auxiliary power units, Controller Pilot Data Link Communication (CPDLC), weather detection systems, Cabin Pressurization Control System (CPCS), fuel systems, checklist systems, primary flight display systems, map systems, Approach and Enroute Navigational Chart systems, Windows Management systems, and display format memory systems. Synoptics pages can include information regarding various aircraft systems including, but not limited to, anti-ice system(s), thrust reverser control system(s), a brake control system(s), flight control system(s), steering control system(s), aircraft sensor control system(s), APU inlet door control system(s), cabin environment control system(s), landing gear control system(s), propulsion system(s), fuel control system(s), lubrication system(s), ground proximity monitoring system(s), aircraft actuator system(s), airframe system(s), avionics system(s), software system(s), air data system(s), auto flight system(s), engine/powerplant/ignition system(s), electrical power system(s), communications system(s), fire protection system(s), hydraulic power system(s), ice and rain protection system(s), navigation system(s), oxygen system(s), pneumatic system(s), information system(s), exhaust system(s), etc.

It should be appreciated that the video signals 500 illustrated in FIG. 5 are exemplary and non-limiting and that in other embodiments other video information or signals from other sources can be provided as inputs to the input selector 410, and output and presented at the display 430 of the CAVU 400. These other sources can include any other source of video information that can provide pilots with information that helps operate the aircraft. The other sources can be onboard the aircraft, or even off the aircraft. For instance, in one embodiment, the aircraft can communicate with a ground station and receive video information or signals that are communicated from the ground to the aircraft and that provide the pilots with information that helps operate the aircraft.

The disclosed embodiments augment natural vision by allowing the flight crew to see all primary flight data and leverages advanced features of aircraft such as Synthetic Vision System (SVS), Enhanced Vision System (EVS), and Head up Display (HUD) data in order to provide a wearable, cost-effective solution for a visually obstructed cockpit environment.

Those of skill in the art would further appreciate that the various illustrative logical blocks/tasks/steps, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The word “exemplary” is used exclusively herein to mean “serving as an example, instance, or illustration.” Any embodiment described herein as “exemplary” is not necessarily to be construed as preferred or advantageous over other embodiments.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description, it should be appreciated that a vast number of variations exist. For example, although embodiments described herein are specific to aircraft, it should be recognized that principles of the inventive subject matter may be applied to other types of vehicles. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A cockpit augmented vision unit (CAVU), comprising:
a video signal feed configured to be communicatively coupled to at least one source of a video signal;
a housing configured to house a display that is coupled to the video signal feed and configured to display the video signal; and
an attachment mechanism coupled to the housing that is configured to secure the housing and the display to an oxygen mask.

2. The CAVU according to claim 1, wherein the video signal feed is communicatively coupled to a plurality of sources of different video signals that are unique from each other, and further comprising:
a video input selector, coupled to the display, and being configured to: receive the different video signals, and output one of the different video signals in response to a user input; and wherein the display is configured to display the one of the different video signals received from the video input selector.

3. The CAVU according to claim 2, further comprising:
one or more user input devices that are configured to receive the user input, and to provide the user input to the input selector.

4. The CAVU according to claim 2, wherein the plurality of different video signals comprise:
a video signal provided from a heads up display (HUD) within the cockpit of the aircraft, wherein the video signal comprises enhanced vision images generated by an enhanced vision system with primary flight control data superimposed on the enhanced vision images.

5. The CAVU according to claim 2, wherein the plurality of different video signals comprise:
a video signal provided from a display unit within the cockpit of the aircraft, the video signal comprising synthetic vision images generated by a synthetic vision system.

6. The CAVU according to claim 2, wherein the aircraft comprises: a flight management system; and a display unit within the cockpit of the aircraft that is configured to display content that is provided from the flight management system, and wherein the plurality of different video signals comprise: a video signal that comprises the content displayed at the display unit.

7. The CAVU according to claim 6, wherein the content displayed at the display unit includes primary flight control data.

8. The CAVU according to claim 2, wherein the content displayed at the MFD unit includes charts or synoptic pages for aircraft systems.

9. The CAVU according to claim 2, further comprising:
a video camera being configured to acquire video images of the cockpit of the aircraft, and
wherein the video input selector is further configured to: receive the different video signals and the video images of the cockpit, and output one of the different video signals and the video images in response to a user input; and wherein the display is configured to display the video images provided from the video camera via the video input selector in response to a particular user input.

10. The CAVU according to claim 9, wherein the video images include actual images of flight deck controls and one or more display units located within the cockpit of the aircraft.

11. An aircraft system, comprising:
an aircraft comprising: at least one source of a video signal; and
an oxygen mask that is configured to be deployed within the aircraft;
a cockpit augmented vision unit (CAVU) communicatively coupled to the source, comprising:
a display;
a housing configured to house the display; and
an attachment mechanism coupled to the housing that is configured to secure the display to the oxygen mask, wherein the display is configured to display the video signal.

12. The aircraft system according to claim 11, wherein the aircraft comprises:
a plurality of sources of different video signals that are unique from each other, and
wherein the CAVU, further comprises:
a video input selector, coupled to the display, and being configured to: receive the different video signals, and output one of the different video signals in response to a user input; and wherein the display is configured to display the one of the different video signals received from the video input selector.

13. The aircraft system according to claim 12, wherein the CAVU further comprises:
one or more user input devices that are configured to receive the user input, and to provide the user input to the input selector.

14. The aircraft system according to claim 12, wherein the aircraft comprises:
an enhanced vision system configured to generate enhanced vision images; and
a heads up display (HUD) within the cockpit of the aircraft; and
wherein the plurality of different video signals comprise: a video signal, provided from the heads up display (HUD), that comprises the enhanced vision images with primary flight control data superimposed on the enhanced vision images.

15. The aircraft system according to claim 12, wherein the aircraft comprises:
a synthetic vision system configured to generate synthetic vision images;
a display unit within the cockpit of the aircraft; and
wherein the plurality of different video signals comprise: a video signal, provided from the display unit, that comprises the synthetic vision images.

16. The aircraft system according to claim 12, wherein the aircraft comprises:
a flight management system;
a display unit within the cockpit of the aircraft that is configured to display content that is provided from the flight management system; and
wherein the plurality of different video signals comprise: a video signal that comprises the content displayed at the display unit.

17. The aircraft system according to claim 16, wherein the content displayed at the display unit includes primary flight control data.

18. The aircraft system according to claim 16, wherein the content displayed at the display unit includes charts or synoptic pages for aircraft systems.

19. The aircraft system according to claim 12, wherein the CAVU further comprises:
a video camera being configured to acquire video images of the cockpit of the aircraft,
wherein the video input selector is further configured to: receive the different video signals and the video images of the cockpit, and output one of the different video signals and the video images in response to a user input; and wherein the display is configured to display the video images provided from video camera via the video input selector in response to a particular user input, wherein the video images include actual images of flight deck controls and one or more display units located within the cockpit of the aircraft.

20. A method, comprising:
communicating a video signal from a source inside an aircraft; and
displaying the video signal on a display that is configured to be secured to an oxygen mask of the aircraft.
